(19) United States
(12) Patent Application Publication
(10) Pub. No.: US 2016/0129421 A1
(43) Pub. Date: May 12, 2016

(54) AEROGEL FOR CAPTURING CARBON DIOXIDE

(71) Applicant: MYONGJI UNIVERSITY INDUSTRY AND ACADEMIA COOPERATION FOUNDATION, Gyeonggi-do (KR)

(72) Inventors: Jeong Gil SEO, Gyeonggi-do (KR); Kyuyoung Lee, Gangwon-do (KR); Hanyeong Lee, Gyeonggi-do (KR); Vishwanath Hiremath, Gyeonggi-do (KR); Seung Ju Han, Gwangju (KR); Yongju Bang, Incheon (KR); Hyuk Jae Kwon, Gyeonggi-do (KR); Hyun Chul Lee, Gyeonggi-do (KR); In Kyu Song, Seoul (KR)

(73) Assignee: MYONGJI UNIVERSITY INDUSTRY AND ACADEMIA COOPERATION FOUNDATION, Gyeonggi-do (KR)

(21) Appl. No.: 14/592,321

(22) Filed: Jan. 8, 2015

(30) Foreign Application Priority Data
Nov. 12, 2014 (KR) 10-2014-0157019

(51) Int. Cl. B01J 20/28; B01J 20/04; B01J 20/30; B01J 20/08

(52) U.S. Cl. CPC B01J 20/28047; B01J 20/08; B01J 20/041; B01J 20/305; B01J 20/3078

(57) ABSTRACT

Disclosed is an aerogel for capturing carbon dioxide (CO₂ ) and, more particularly an aerogel for capturing CO₂ and a preparation method for the same, where the aerogel for capturing CO₂ is prepared using a magnesium precursor and an aluminum precursor by an epoxide-driven sol-gel method and a subsequent drying method using supercritical carbon dioxide to have a high CO₂ adsorptive performance at elevated temperature. There is provided an aerogel for capturing CO₂ to selectively adsorb CO₂ at elevated temperature, thereby contributing to the reduction of the CO₂ emission that is mainly responsible for atmospheric pollutions by using the high-efficiency aerogel for capturing CO₂ with high CO₂ selectivity, high CO₂ adsorption performance, and good recyclability in the repetitive adsorption-desorption processes.

### SPECIFIC REFERENCE TO A GRACE PERIOD INVENTOR DISCLOSURE

This invention has been published as a title of Elevated temperature CO₂ capture on nano-structured MgO—Al₂O₃ aerogel: Effect of Mg/Al molar ratio, in Chemical Engineering Journal 242 (2014) pp. 357-363 on Jan. 8, 2014, by the inventor or joint inventors.

### TECHNICAL FIELD

The present invention relates to an aerogel for capturing carbon dioxide (CO₂ ) and, more particularly to an aerogel for capturing CO₂ and a preparation method for the same, where the aerogel for capturing CO₂ is prepared using a magnesium precursor and an aluminum precursor by an epoxide-driven sol-gel method and a subsequent drying method using supercritical carbon dioxide to have a high CO₂ adsorptive performance at elevated temperature.

### BACKGROUND ART

Coal-, oil-, and natural gas-fired power plants are the major contributor to emission of greenhouse gases. In particular, carbon dioxide (CO₂) is the primary greenhouse gas accounting for the highest percentage of greenhouse-gas emissions and known to be mainly responsible for global warming. Unfortunately, it is impossible for a single nation to efficiently cope with the global atmospheric pollution caused by greenhouse-gas emissions and subsequent global climate change. In recent years, worldwide efforts are underway to improve the global environments, like establishing United Nations Framework Convention on Climate Change (UNFCCC), etc.

As part of such an effort to improve the global environments, advanced technologies are under development to achieve CO₂ capture, storage (sequestration), and utilization in many different fields. Among the various adsorption-based technologies to capture CO₂ particularly from power plants, the adsorption-based method for CO₂ adsorption on solid media has been considered as the most promising technology, because it has high CO₂ adsorption capacity and low energy cost to recycle the used adsorbent under CO₂ adsorption-desorption processes.

For example, a variety of inorganic adsorbents, such as alkaline metal oxides (carbonates), hydrotalcites (HTCs), double salts, etc., have been used in the pre-combustion CO₂ capture that required high temperature above 200° C. Among the various inorganic adsorbents, hydrotalcites (HTCs) or hydrotalcite-based layered dioxides (LDOₛ) are known as practical candidates for pre-combustion CO₂ capture due to their high surface area and abundant base sites on the surface, which are favorable for accommodating acidic CO₂. However, relatively poor CO₂ adsorption capacity is the major disadvantage of the hydrotalcites or hydrotalcite-based layered dioxides for the CO₂ capture.

Magnesium oxide is also known as a plausible CO₂ absorbent, yet it still has problems in regards to its poor stability and high energy cost to recycle the used adsorbent under the CO₂ adsorption-desorption processes.

Accordingly, the inventors of the present invention have made studies on the CO₂ absorbents using aerogel that have considerably large surface area and pore volume due to their high porosity and thus can be used as effective CO₂ adsorbents, thereby completing the invention relating to an aerogel for CO₂ capture and its preparation method, where the aerogel for CO₂ capture is prepared using a magnesium precursor and an aluminum precursor by an epoxide-driven sol-gel method and a subsequent drying method using supercritical CO₂ to achieve high CO₂ adsorptive performance at elevated temperature.

The related prior art includes Korean Laid-Open Patent No. 10-2012-0025679 (a carbon dioxide adsorbent and its preparation method), Korean Registration Patent No. 10-0384256 (a carbon dioxide adsorbent containing magnesium oxide suitable for high temperature), etc.

### DISCLOSURE OF INVENTION

It is an object of the present invention to provide a high-efficiency aerogel for capturing CO₂ and its preparation method, where the aerogel for capturing CO₂ is prepared using a magnesium precursor and an aluminum precursor by an epoxide-driven sol-gel method and a subsequent drying method using supercritical CO₂ to achieve excellences in CO₂ adsorptive performance at elevated temperature and recyclability.

To achieve the object, the present invention provides an aerogel for capturing carbon dioxide that includes an MgO—Al₂O₃ complex.

The MgO—Al₂O₃ complex is prepared using a magnesium precursor and an aluminum precursor through a sol-gel reaction.

The mole fraction of Mg in the Mg—Al compound in the MgO—Al₂O₃ complex is 0.5 to 3.

The magnesium precursor is magnesium nitrate hydrate, and the aluminum precursor is aluminum nitrate hydrate.

The present invention also provides a method for preparing an aerogel for capturing carbon dioxide that includes: (1) simultaneously dissolving a magnesium precursor and an aluminum precursor in ethanol and vigorously stirring the resulting solution to form a sol; (2) adding a gelling agent to the sol of the step (1) to form a gel; (3) aging the gel of the step (2); (4) adding liquid carbon dioxide to the gel aged in the step (3) to eliminate the remaining sol from the gel; (5) eliminating ethanol from the gel of the step (4) and adding supercritical carbon dioxide to dry the gel; and (6) calcining the dried gel of the step (5).

The stirring process of the step (1) is performed at the room temperature for 15 to 45 minutes.

The gelling agent of the step (2) is propylene oxide.

The aging process of the step (3) is performed for 1 to 3 days.

The addition of the liquid carbon dioxide in the step (4) is performed at 20° C. and 100 atm for 4 hours.

The addition of the supercritical carbon dioxide in the step (5) is performed at 50° C. and 100 atm for 2 hours.

The calcination process of the step (6) is performed at 600° C. for 5 hours.

### EFFECTS OF THE INVENTION

According to the present invention, an aerogel for capturing carbon dioxide that includes an MgO—Al₂O₃ complex can be prepared by a sol-gel method and a drying method using supercritical carbon dioxide. This can provide a high-efficiency CO₂ absorbent capable of stably adsorbing CO₂ at elevated temperature and recyclable at low energy cost.

### BRIEF DESCRIPTION OF DRAWINGS

FIG. 1 shows N₂ adsorption-desorption isotherms of the aerogels for capturing carbon dioxide prepared in the present invention as a function of the mole fraction of Mg in the Mg—Al compound (hereinafter, referred to as “Mg/Al molar ratio”).

FIG. 2 shows FE-SEM (Field Emission Scanning Electron Microscope) images of the aerogels for capturing carbon dioxide prepared in the present invention according to the Mg/Al molar ratio.

FIG. 3 shows STEM (Scanning Transmission Electron Microscope) images of the aerogels for capturing carbon dioxide prepared in the present invention when the Mg/Al molar ratio is 0.5 or 3.

FIG. 4 shows X-ray diffraction patterns of the aerogels for capturing carbon dioxide prepared in the present invention according to the Mg/Al molar ratio.

FIG. 5 shows CO₂-TPD (Temperature-Programmed Desorption) profiles of the aerogels for capturing carbon dioxide prepared in the present invention according to the Mg/Al molar ratio. FIG. 6 shows CO₂ breakthrough curves of the aerogels for capturing carbon dioxide prepared in the present invention as a function of the Mg/Al molar ratio.

FIG. 7 shows total CO₂ adsorption capacity and 90% breakthrough CO₂ adsorption capacity of the aerogels for capturing carbon dioxide prepared in the present invention, plotted as a function of the Mg/Al molar ratio.

FIG. 8 shows medium basicity and 90% breakthrough CO₂ adsorption capacity of the aerogels for capturing carbon dioxide prepared in the present invention, plotted as a function of the Mg/Al molar ratio.

BEST MODES FOR CARRYING OUT THE INVENTION

Hereinafter, the present invention will be described in detail.

The present invention provides an aerogel for capturing carbon dioxide that includes an MgO—Al₂O₃ complex. Aerogels are representative super-porous nan-structured materials prepared from a wet gel obtained by the sol-gel method through a drying process without shrinking under supercritical conditions, which create no gas-liquid interface, while maintaining the porous structure of the gel. The present invention prepares an aerogel based on an MgO—Al₂O₃ complex to achieve a capability for selectively adsorbing carbon dioxide at elevated temperature.

The MgO—Al₂O₃ complex is prepared using a magnesium precursor and an aluminum precursor through a sol-gel reaction.

In the MgO—Al₂O₃ complex, the mole fraction of Mg to the Mg/Al compound (hereinafter, referred to as “Mg/Al molar ratio”) is 0.5 to 3. An analysis of the aerogel of the present invention in regards to the properties and CO₂ adsorption capacity as measured according to the different Mg/Al molar ratios (0, 0.5, 1.0, 2.0, or 3.0) reveals that the aerogel can acquire the optimum properties when the Mg/Al molar ratio is 0.5.

The magnesium precursor is magnesium nitrate hydrate, and the aluminum precursor is aluminum nitrate hydrate.

The present invention also provides a method for preparing an aerogel for capturing carbon dioxide that includes: (1) simultaneously dissolving a magnesium precursor and an aluminum precursor in ethanol and vigorously stirring the resulting solution to form a sol; (2) adding a gelling agent to the sol of the step (1) to form a gel; (3) aging the gel of the step (2); (4) adding liquid carbon dioxide to the gel aged in the step (3) to eliminate the remaining sol from the gel; (5) eliminating ethanol from the gel of the step (4) and adding supercritical carbon dioxide to dry the gel; and (6) calcining the dried gel of the step (5).

The stirring process of the step (1) is performed at the room temperature for 15 to 45 minutes, most preferably for 30 minutes.

The subsequent step (2) involves adding a gelling agent to the sol. The gelling agent is preferably propylene oxide. It is general that the sol-gel process mostly uses metal alkoxides as precursors, for the metal alkoxides are highly active towards nucleophilic reactions and feasible in regards to the selection of an appropriate solvent. But, most of the alkoxide precursors are too expensive to have commercial feasibility. Further, the alkoxide precursors are much vulnerable to heat, light and water and none of them other than Si, Al, Ti, or Zr are yet available commercially. In this matter of fact, the sol-gel method using non-alkoxide precursors such as general metal salts as a substitute for the problematic alkoxide precursors is a very practical means to make the aerogels available on a commercial scale. What is vital in the preparation of a gel using such non-alkoxide precursors is the use of epoxide as a gelling accelerator, which epoxide acts as a proton scavenger in the solution to gradually increase the pH and lead to gelation. In the present invention, the gelling accelerator is propylene epoxide, that is, propylene oxide.

The aging process of the step (3 ) is performed for 1 to 3 days, most preferably for 2 days. In the step (4 ), liquid carbon dioxide is added to the gel at 20° C. and 100 atm for 4 hours in order to eliminate the remaining sol from the gel.

Subsequently, the resulting gel is removed of the ethanol and then dried out by adding supercritical carbon dioxide. As the sol-gel reaction forms a wet gel, it is required to perform a drying process to eliminate the solvent contained in the gel structure. During the general drying process, liquid and vapor coexist in the pores of the gel and, as the liquid evaporates, the surface tension in the gas-liquid interface creates a meniscus, that is, a curved surface of the liquid in the tube caused by the capillary action. In this case, the capillary pressure of the gas-liquid interface in each pore is so considerably high as to impose a force locally on the very narrow area where the wet pore wall meets the meniscus. Such a local force can cause the gel to shrink, so the gel under the drying process is highly liable to lose its original structure. It is therefore possible to maintain the structure of the wet gel almost to the original state through a drying process by removing the gel of the solvent under the supercritical conditions, above the critical temperature and the critical pressure, under which no gas-liquid interface exists. The aerogel prepared by this drying method has such a super-porous structure as to exhibit various characteristic properties. Accordingly, the present invention employs the supercritical drying process in order to make the resulting gel capable of easily adsorbing carbon dioxide without destroying the porous structure of the gel.

In general, the supercritical drying process is divided into the high-temperature supercritical drying process and the low-temperature supercritical drying process. The high-temperature supercritical drying process is applied to the preparation of a silica aerogel that is an advanced material. The low-temperature supercritical drying process, using carbon dioxide, involves a relatively simple process that is more economical and safer than the high-temperature supercritical drying process. The present invention adopts the low-temperature supercritical drying process using carbon dioxide. The addition of supercritical carbon dioxide is performed at 50° C. and 100 atm for 2 hours.

The dried gel is subjected to calcination at 600° C. for 5 hours to produce an aerogel for capturing carbon dioxide that includes an MgO—Al₂ O₃ complex.

Hereinafter, a detailed description will be given as to the construction and effects of the present invention more specifically with reference to Experimental Examples and Examples, which are given only to help the better understanding of the present invention and not intended to limit the scope of the present invention.

### EXAMPLE 1

1.14 g of magnesium nitrate hexahydrate (Sigma-Aldrich) and 6.00 g of aluminum nitrate nonahydrate (Signma-Aldrich) are simultaneously added to 30 ml of ethanol, and the resulting solution is vigorously stirred at the room temperature for 30 minutes to form a sol. 14.7 ml of propylene oxide is added to the sol thus obtained to cause gelation of the sol. In this regard, the molar ratio of propylene oxide to total metal (Al+Mg) is fixed at 10. After a few minutes, a gel can be obtained. The gel thus obtained is aged for 2 days and then removed of the remaining sol in a stream of liquid carbon dioxide at 20° C. and 100 atm for 4 hours. The ethanol is eliminated from the gel, which is then dried out in a stream of supercritical carbon dioxide at 50° C. and 100 atm for 2 hours. Finally, the resulting gel is calcined at 600° C. for 5 hours in a calciner to yield an aerogel for capturing carbon dioxide that includes an MgO—Al₂O₃ complex as denoted as MgAl-AE-X (X=0, 0.5, 1.0, 2.0, or 3.0), where X represents the Mg/Al molar ratio.

TABLE 1
Detailed structural properties of aerogels for CO₂ capture
of the present invention according to Mg/Al molar ratio.

| | BET surface | Pore volume^{(b)} | Pore diameter^{(c)} |
|---|---|---|---|
| Adsorbent | area^{(a)} (m²/g) | (cm³/g) | (nm) |
| MgAl-AE-0 | 435 | 1.24 | 11.4 |
| MgAl-AE-0.5 | 409 | 1.40 | 13.7 |
| MgAl-AE-1.0 | 322 | 1.02 | 12.7 |
| MgAl-AE-2.0 | 231 | 0.59 | 10.2 |
| MgAl-AE-3.0 | 180 | 0.33 | 7.4 |

^{(a)}Calculated by the BET equation.
^{(b)}Total pore volume at P/P₀ ~0.995.
^{(c)}Mean pore diameter.

As can be seen from Table 1, surface area, pore volume, and pore diameter decrease with an increase in the Mg/Al molar ratio. Nevertheless, all the adsorbents exhibit high specific surface area (≧180 m²/g), large pore volume (≧0.33 cm³/g), and large pore diameter (≧7.4 nm).

TABLE 2
Basicity of aerogels for CO₂ capture of the present
invention according to Mg/Al molar ratio.

Amount of CO₂ desorbed (mmol-CO₂/g)

| | Weak site | Medium site | |
|---|---|---|---|
| Adsorbent | (<200° C.) | (200-300° C.) | Total |
| MgAl-AE-0 | 0.04 (21.7%) | 0.14 (78.3%) | 0.18 |
| MgAl-AE-0.5 | 0.11 (11.1%) | 0.86 (88.9%) | 0.97 |
| MgAl-AE-1.0 | 0.07 (10.4%) | 0.62 (89.6%) | 0.69 |
| MgAl-AE-2.0 | 0.04 (6.2%) | 0.56 (93.8%) | 0.60 |
| MgAl-AE-3.0 | 0.06 (10.8%) | 0.48 (89.2%) | 0.54 |

As can be seen from Table 2, the aerogel having the Mg/Al molar ratio of 0.5 exhibits the largest basicity. Interestingly, it is observed that the aerogels having the Mg/Al molar ratio of 0.5, 1.0, 2.0, or 3.0 retain increased basicity compared to the aerogel having the Mg/Al molar ratio of 0. This result is attributed to the fact that uniformly incorporated aluminum ion (Al³⁺) in the magnesium oxide (MgO) lattice creates a surface defect in order to compensate the positive charges generated, and consequently the adjacent surface oxygen ion becomes coordinately unsaturated, resulting in a formation of highly basic surface magnesium aluminate. However, charge compensation effect on the surface by the aluminum ion (Al³⁺) incorporation into the magnesium oxide (MgO) decreases with an increase in the Mg/Al molar ratio. With this, the structures of the bulk magnesium aluminate spinel and segregated magnesium oxide (MgO) are mostly less important in the aerogel for capturing carbon dioxide as prepared in the present invention. This fact can be seen from the results of the X-ray diffraction (XRD) analysis. In addition, the drastic decrease of the surface area of the magnesium-rich adsorbent can be another reason for the decrease of the basicity. Consequently, the aerogel having the Mg/Al molar ratio of 0.5 exhibits the largest surface area and the highest basicity on the magnesium aluminate surface.

TABLE 3
CO₂ adsorption capacity of aerogels for CO₂ capture of the
present invention according to Mg/Al molar ratio, where the CO₂
adsorption capacity is calculated by integrating the area below
the breakthrough curves of FIG. 6.

| | | 90% breakthrough CO₂ |
|---|---|---|
| | Total CO₂ adsorption | adsorption capacity |
| Adsorbent | capacity (wt %) | (wt %) |
| MgAl-AE-0 | 0.57 | 0.49 |
| MgAl-AE-0.5 | 2.59 | 2.22 |
| MgAl-AE-1.0 | 1.60 | 1.20 |
| MgAl-AE-2.0 | 1.12 | 0.89 |
| MgAl-AE-3.0 | 0.78 | 0.56 |
| Pural MG70 | 0.51 | 0.47 |

For compensation, the CO₂ adsorption capacity of Pural MG70 commercially available, which is composed of 70% magnesium oxide (MgO ) and 30% aluminum oxide (Al₂O₃), is measured under the same conditions. It is noticeable that all the aerogels for capturing carbon dioxide according to the present invention exhibit greater CO₂ adsorption capacity than Pural MG70.

### MEASUREMENT EXAMPLE 1

### N₂ Adsorption-Desorption Behaviors of the Aerogels for CO₂ Capture Prepared in the Present Invention According to Mg/Al Molar Ratio

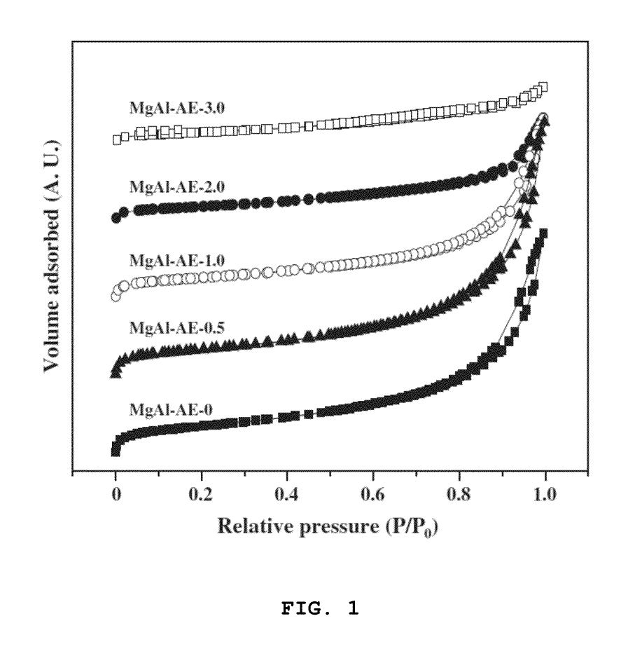

The aerogels for CO₂ capture prepared in the present invention are measured in regards to the CO₂ adsorption-desorption behavior according to the Mg/Al molar ratio. As a result, as can be seen from FIG. 1, all the aerogels of the present invention show IV-type N₂ adsorption-desorption isotherms and H1-ype hysteresis loop. This indicates that all the aerogels are materials with medium-sized pores.

### MEASUREMENT EXAMPLE 2

### Surface Structure of the Aerogels for CO₂ Capture Prepared in the Present Invention According to Mg/Al Molar Ratio

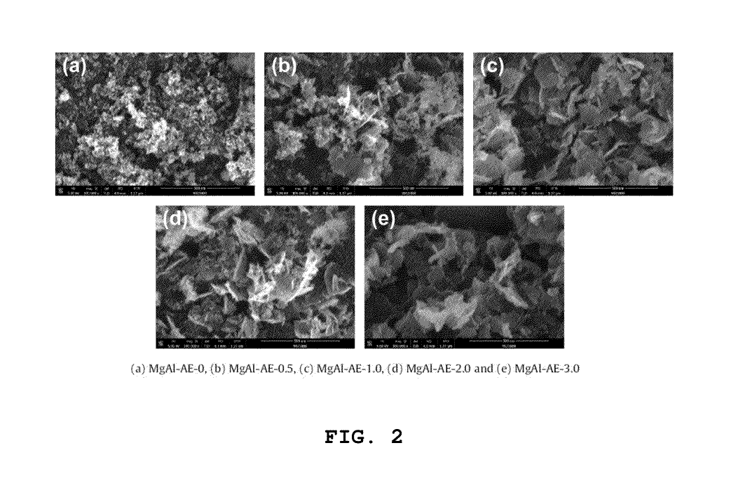

The aerogels for CO₂ capture prepared in the present invention are analyzed in regards to the morphology according to the Mg/Al molar ratio through FE-SEM (Field Emission Scanning Electron Microscope). As can be seen from FIG. 2, the particle size and assembling morphologies are varied. The aerogel having an Mg/Al molar ratio of 0 exhibits amorphous morphology, while other aerogels has a flower-like nano-architecture of nano-sized flakes with an average diameter of 0.1 to 0.2 μm. Such nano-sized flakes are produced by the drying method using supercritical carbon dioxide. Interestingly, the particle size of the aerogels increases with an increase in the Mg/Al molar ratio. This can be explained by the fact that aluminum oxide (Al₂O₃) has a larger surface area in spite of the smaller particle size than magnesium oxide (MgO).

### MEASUREMENT EXAMPLE 3

### Crystalline Structure of the Aerogels for CO₂ Capture Prepared in the Present Invention When Mg/Al Molar Ratio is 0.5 or 3.0

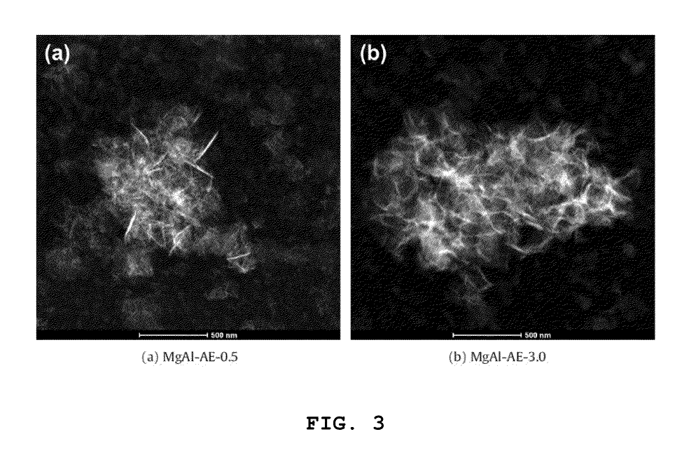

The aerogels for CO₂ capture prepared in the present invention are analyzed through STEM (Scanning Transmission Electron Microscope) in regards to the crystalline structure when the Mg/Al molar ratio is 0.5 or 3.0. The aerogel having an Mg/Al molar ratio of 0.5 is rich in aluminum (Al) and the aerogel having an Mg/Al molar ratio of 3.0 is rich in magnesium (Mg). As can be seen from FIG. 3, both the aluminum-rich aerogel and the magnesium-rich aerogel have a flower-like nano-architecture with nano-sized flakes.

### MEASUREMENT EXAMPLE 4

### X-Ray Diffraction Patterns of the Aerogels for CO₂ Capture Prepared in the Present Invention According to Mg/Al Molar Ratio

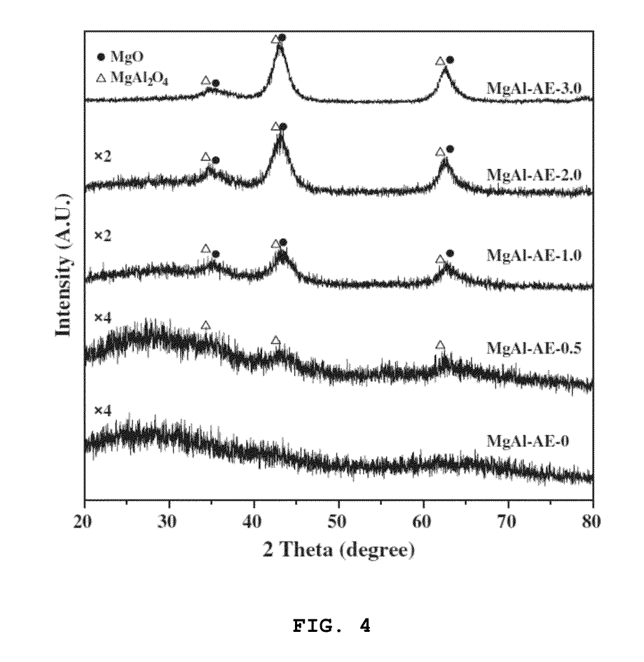

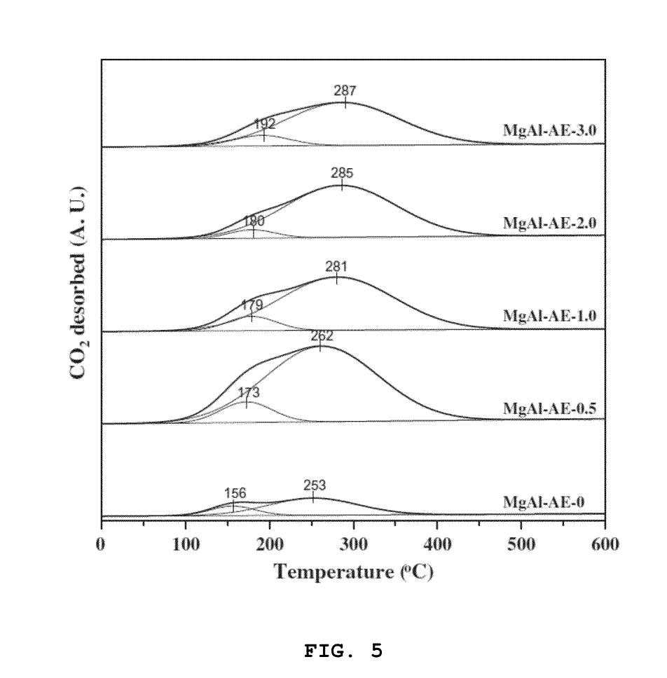

The aerogels for CO₂ capture prepared in the present invention are analyzed through X-ray diffraction patterns in regards to the crystalline structure according to the Mg/Al molar ratio. As can be seen from FIG. 4, all the aerogels, except for the one having an Mg/Al molar ratio of 0, display three distinct diffraction peaks, which are indicative of magnesium alumina spinel phase. It is assumed that stoichiometric spinel (MgAl₂O₄) is formed in the aerogel having an Mg/Al molar ratio of 0.5. This is presumably due to the fact that aluminum ions (Al³⁺) are finely dispersed in the magnesium oxide (MgO ) lattice during the epoxide-driven sol-gel reaction, resulting in the lattice shrinkage of MgO. On the other hand, the aerogels have a structure of MgO—MgAl₂O₄when the Mg/Al molar ratio is 1 or greater. From this result, it can be deduced that the Mg/Al molar ratio has a great effect on the crystalline structure of the aerogels for CO₂capture that includes an MgO—Al₂O₃complex.

### MEASUREMENT EXAMPLE 5

### CO₂ TPD Profiles of the Aerogels for CO₂ Capture Prepared in the Present Invention According to Mg/Al Molar Ratio

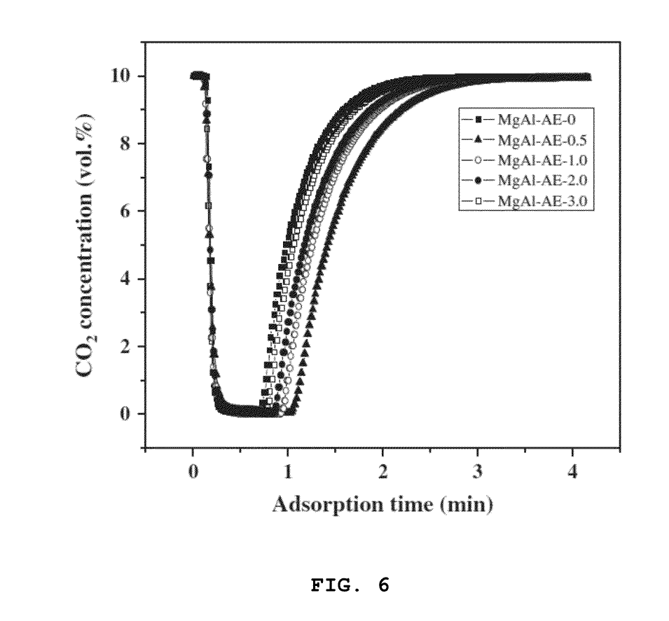

The aerogels for CO₂ capture prepared in the present invention are analyzed through TPD (Temperature-Programmed Desorption) experiments to determine the difference based on the Mg/Al molar ratio. The TPD experiments determine the basicity of the aerogels for CO₂ capture. FIG. 5 shows the CO₂ adsorption capacity of each aerogel as a function of the temperature, and the corresponding base site. It is interesting to note that none of the aerogels has strong base sites, which usually appear at high temperature (>300° C.). This implicitly means that unidentate carbonate is formed through the carbonation reaction between the aerogels and CO₂ . This is presumably due to the fact that the basicity of the materials based on aluminum oxide increases with an increase in the crystallization temperature, for the aerogels with poor crystallization have only weak or medium base sites. The desorption peaks that appear at low temperature (<200° C., weak base site) is attributed to the weak chemisorption of CO₂ on the hydroxyl groups of the surface that takes weak base, resulting in a formation of bicarbonate. The desorption peaks that appear at high temperature (>300° C.) have something to do with the chemisorption of CO₂ on the magnesium ion (Mg²⁺) and oxygen ion (O²⁻) pairs in the form of bidentate carbonate. The peak temperature of both weak and medium sites in the aerogels for CO₂ capture prepared in the present invention (with an Mg/Al molar ratio of 0 or 0.5 ) increases with an increase in the Mg/Al molar ratio. This is because the base strength of the oxygen ion (CO₂₋) is stronger due to more coordinative unsaturation. On the other hand, the oxygen on the surface of the non-stoichiometric spinel, which mainly coordinated with divalent metal, more readily reacts with CO₂ than the oxygen on the surface of the stoichiometric spinel, which mainly coordinated with trivalent metal.

### MEASUREMENT EXAMPLE 6

### CO₂ Breakthrough Curves of the Aerogels for CO₂ Capture Prepared in the Present Invention According to Mg/Al Molar Ratio

For acquire the breakthrough curves, 10% CO₂ diluted with 90 vol % N₂ is used at 200° C. As can be seen from FIG. 6, all the aerogels for CO₂ capture exhibit valley-shaped curves, but the breakthrough time is greatly influenced by the Mg/Al molar ratio.

### MEASUREMENT EXAMPLE 7

### Total CO₂ Adsorption Capacity and 90% Breakthrough CO₂ Adsorption Capacity of the Aerogels for CO₂ Capture Prepared in the Present Invention According to Mg/Al Molar Ratio

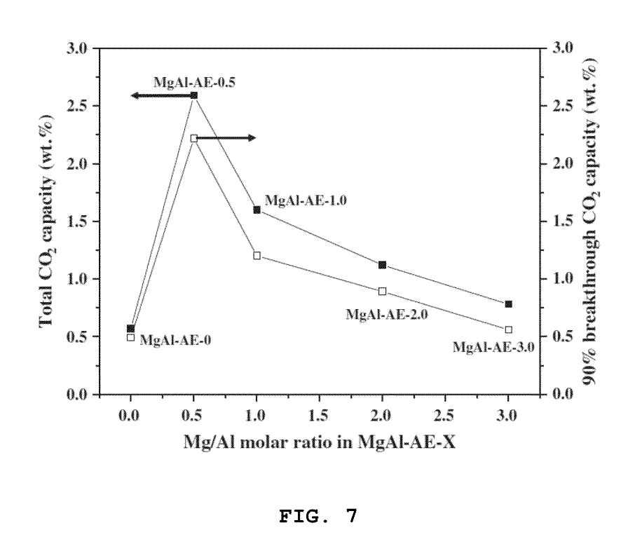

The aerogels for CO₂ capture prepared in the present invention are measured in regards to the total CO₂ adsorption capacity and the 90% breakthrough CO₂ adsorption capacity, as a function of the Mg/Al molar ratio. Referring to FIG. 7, there is no significant difference between the total CO₂ adsorption capacity and the 90% breakthrough CO₂ adsorption capacity. This means that the CO₂ adsorption is fast enough to disregard the pressure drop and mass transfer limitation. Both the total CO₂ adsorption capacity and the 90% breakthrough CO₂ adsorption capacity display a volcano-shaped curve. Among the aerogels tested, the aerogel having an Mg/Al molar ratio of 0.5 shows the best CO₂ adsorption efficiency.

### MEASUREMENT EXAMPLE 8

### Basicity and 90% Breakthrough CO₂ Adsorption Capacity of the Aerogels for CO₂ Capture Prepared in the Present Invention According to Mg/Al Molar Ratio

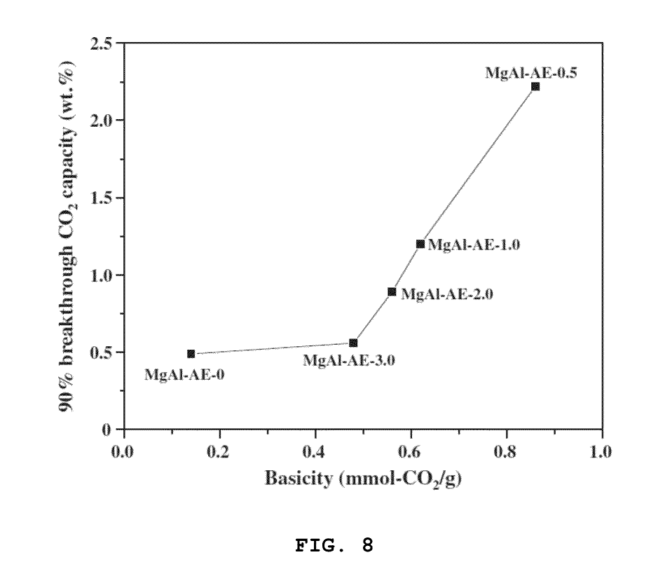

The aerogels for CO₂ capture prepared in the present invention are measured in regards to the basicity and the 90% breakthrough CO₂ adsorption capacity, as a function of the Mg/Al molar ratio. As can be seen from FIG. 8, the 90% breakthrough CO₂ adsorption capacity increases with an increase in the medium basicity of the aerogels for CO₂ capture. Such a correlation clearly shows that the medium basicity functions as an important factor in determining the adsorptive performance of the aerogels at elevated flue-gas temperature. These results also show that the medium base site serves as a major adsorption site in the CO₂ adsorption process. Among the aerogels tested, the aerogel having an Mg/Al molar ratio of 0.5 exhibits the highest medium basicity and also the highest CO₂ adsorption efficiency.

Although the present invention has been described with reference to the particular illustrative embodiments, it is apparent to those skilled in the art that the illustrative embodiments are given as preferred embodiments and not intended to limit the scope of the present invention. Therefore, the substantial scope of the present invention should be defined by the following claims and equivalents thereof.

What is claimed is:

1. An aerogel for capturing carbon dioxide, comprising an MgO—Al₂ O₃ complex.

2. The aerogel for capturing carbon dioxide as claimed in claim 1, wherein the MgO—Al₂O₃ complex is prepared using a magnesium precursor and an aluminum precursor through a sol-gel reaction.

3. The aerogel for capturing carbon dioxide as claimed in claim 1, wherein the mole fraction of Mg in the Mg—Al compound in the MgO—Al₂ O₃ complex is 0.5 to 3.

4. The aerogel for capturing carbon dioxide as claimed in claim 2, wherein the magnesium precursor is magnesium nitrate hydrate, and the aluminum precursor is aluminum nitrate hydrate.

5. A method for preparing an aerogel for capturing carbon dioxide, comprising:
(1) simultaneously dissolving a magnesium precursor and an aluminum precursor in ethanol and vigorously stirring the resulting solution to form a sol;
(2) adding a gelling agent to the sol of the step (1) to form a gel;
(3) aging the gel of the step (2);
(4) adding liquid carbon dioxide to the gel aged in the step (3) to eliminate the remaining sol from the gel;
(5) eliminating ethanol from the gel of the step (4) and adding supercritical carbon dioxide to dry the gel; and
(6) calcining the dried gel of the step (5).

6. The method as claimed in claim 5, wherein the stirring process of the step (1) is performed at the room temperature for 15 to 45 minutes.

7. The method as claimed in claim 5, wherein the gelling agent of the step (2) is propylene oxide.

8. The method as claimed in claim 5, wherein the aging process of the step (3) is performed for 1 to 3 days.

9. The method as claimed in claim 5, wherein the addition of the liquid carbon dioxide in the step (4) is performed at 20° C. and 100 atm for 4 hours.

10. The method as claimed in claim 5, wherein the addition of the supercritical carbon dioxide in the step (5) is performed at 50° C. and 100 atm for 2 hours.

11. The method as claimed in claim 5, wherein the calcination process of the step (6) is performed at 600° C. for 5 hours.
